(19) United States
(12) Patent Application Publication
(10) Pub. No.: US 2026/0036482 A1
(43) Pub. Date: Feb. 5, 2026

(54) TRAINING APPARATUS, TRAINING METHOD, DIAGNOSIS APPARATUS FOR DIAGNOSING EQUIPMENT ANOMALY BASED ON VIBRATION SIGNAL OF TIME DOMAIN, AND ABNORMALITY DIAGNOSIS METHOD

(71) Applicants: TECH UNIVERSITY OF KOREA INDUSTRY ACADEMIC COOPERATION FOUNDATION, Gyeonggi-do (KR); RESHENIE CORP., Gyeonggi-do (KR)

(72) Inventors: Yong Kwan LEE, Gyeonggi-do (KR); Ki Chang PARK, Gyeonggi-do (KR)

(21) Appl. No.: 18/941,685

(22) Filed: Nov. 8, 2024

(30) Foreign Application Priority Data
Jul. 31, 2024 (KR) 10-2024-0101968

(51) Int. Cl. G01M 1/14; G01H 11/08; G01M 13/045; G06N 20/00

(52) U.S. Cl. CPC G01M 1/14; G01H 11/08; G01M 13/045; G06N 20/00

(57) ABSTRACT

Provided is a training apparatus, a training method, a diagnosis apparatus for diagnosing equipment anomaly. A training apparatus includes a processor, and a memory configured to store instructions executable by the processor. The instructions cause the training apparatus to obtain a vibration signal of a time domain obtained by measuring a vibration that occurs when equipment is operating normally, obtain a vibration signal for each frequency band filtered according to defined frequency bands by inputting the vibration signal to at least one filter, train a signal reconstruction model using the vibration signal for each frequency band, obtain a reconstruction signal corresponding to each frequency band, determine a reconstruction error value showing a difference between the vibration signal for each frequency band and the reconstruction signal, and determine a threshold value for anomaly detection based on the reconstruction error value determined for each of the defined frequency bands.

### CROSS-REFERENCE TO RELATED APPLICATION

This application claims the benefit of Korean Patent Application No. 10-2024-0101968 filed on Jul. 31, 2024, in the Korean Intellectual Property Office, the entire disclosure of which is incorporated herein by reference for all purposes.

### BACKGROUND

### 1. Field of the Invention

One or more embodiments relate to a training apparatus, a training method, a diagnosis apparatus for diagnosing equipment anomaly based on a vibration signal of a time domain, and an abnormality diagnosis method.

### 2. Description of the Related Art

Equipment abnormality diagnosis technology using equipment vibration is a technology for diagnosing whether there is an anomaly in equipment by analyzing a vibration signal measured from the equipment. An unsupervised learning type artificial intelligence (AI) model may be used to diagnose the equipment abnormality using a vibration of the equipment. The unsupervised learning type AI model may be trained using a large amount of vibration data collected during a normal operation of the equipment. Vibration data may include data in a frequency domain or data in a time domain.

### SUMMARY

According to an aspect, there is provided a training apparatus including a processor, and a memory configured to store instructions executable by the processor. The instructions, when executed by the processor, cause the training apparatus to obtain a vibration signal of a time domain obtained by measuring a vibration that occurs when equipment is operating normally through a vibration sensor, obtain a vibration signal for each frequency band filtered according to defined frequency bands by inputting the vibration signal to at least one filter, train a signal reconstruction model corresponding to each of the defined frequency bands using the vibration signal for each frequency band, obtain a reconstruction signal corresponding to each frequency band through the trained signal reconstruction model for each frequency band, determine a reconstruction error value showing a difference between the vibration signal for each frequency band and the reconstruction signal corresponding to each frequency band, and determine a threshold value for anomaly detection corresponding to each of the defined frequency bands based on the reconstruction error value determined for each of the defined frequency bands.

The signal reconstruction model may include at least one of an autoencoder, a stacked autoencoder, a long short-term memory (LSTM) autoencoder, and a convolutional autoencoder.

The instructions, when executed by the processor, may cause the training apparatus to determine the reconstruction error value based on at least one of an average value of differences between the vibration signal for each frequency band and the reconstruction signal corresponding to each frequency band, an average value of squares of the differences, and a square root value of the average value of the squares of the differences.

The instructions, when executed by the processor, may cause the training apparatus to determine a threshold value of the reconstruction error value based on the three-sigma rule or a maximum value of the reconstruction error value for each frequency band.

According to another aspect, there is provided an abnormality diagnosis apparatus for diagnosing an anomaly of equipment using a signal reconstruction model, the abnormality diagnosis apparatus including a processor, and a memory configured to store instructions executable by the processor. The instructions, when executed by the processor, cause the training apparatus to obtain a vibration signal of a time domain obtained by measuring a vibration that occurs in equipment through a vibration sensor, obtain a vibration signal for each frequency band filtered according to each defined frequency band by inputting the vibration signal to at least one filter, obtain reconstruction signals corresponding to each defined frequency band from each signal reconstruction model by inputting the vibration signal for each frequency band to the signal reconstruction model corresponding to a frequency band, determine a reconstruction error value showing a difference between the vibration signal for each frequency band and the reconstruction signal corresponding to each frequency band, and determine the anomaly of the equipment based on an error value determined for each defined frequency band and a threshold value determined for each defined frequency band.

The instructions, when executed by the processor, may cause the training apparatus to, when at least one of the reconstruction error value determined for each frequency band is greater than a corresponding threshold value, determine that there is the anomaly in the equipment.

The instructions, when executed by the processor, may cause the training apparatus to, when the reconstruction error value determined for each frequency band is less than or equal to a corresponding threshold value, determine that the equipment is in a normal state.

The instructions, when executed by the processor, may cause the training apparatus to determine the reconstruction error value based on at least one of an average value of differences between the vibration signal for each frequency band and the reconstruction signal corresponding to each frequency band, an average value of squares of the differences, and a square root value of the average value of the squares of the differences.

The instructions, when executed by the processor, may cause the training apparatus to, as a result of comparing the reconstruction error value determined for each frequency band with the threshold value determined for each frequency band, when a frequency band in which the reconstruction error value is greater than a corresponding threshold value is detected, estimate an anomaly type based on the detected frequency band.

According to still another aspect, there is provided a training method of training a signal reconstruction model by a training apparatus, the training method including obtaining a vibration signal of a time domain obtained by measuring a vibration that occurs when equipment is operating normally through a vibration sensor, obtaining a vibration signal for each frequency band filtered according to defined frequency bands by inputting the vibration signal to at least one filter, training a signal reconstruction model corresponding to each of the defined frequency bands using the vibration signal for each frequency band, obtaining a reconstruction signal corresponding to each frequency band through the trained signal reconstruction model for each frequency band, determining a reconstruction error value showing a difference between the vibration signal for each frequency band and the reconstruction signal corresponding to each frequency band, and determining a threshold value for anomaly detection corresponding to each of the defined frequency bands based on the reconstruction error value determined for each of the defined frequency bands.

The determining of the reconstruction error value may include determining the reconstruction error value based on at least one of an average value of differences between the vibration signal for each frequency band and the reconstruction signal corresponding to each frequency band, an average value of squares of the differences, and a square root value of the average value of the squares of the differences.

The determining of the threshold value may include determining a threshold value of the reconstruction error value based on the three-sigma rule or a maximum value of the reconstruction error value for each frequency band.

According to still another aspect, there is provided an abnormality diagnosis method of diagnosing an anomaly of equipment performed by an abnormality diagnosis apparatus, the abnormality diagnosis method including obtaining a vibration signal of a time domain obtained by measuring a vibration that occurs in the equipment through a vibration sensor, obtaining a vibration signal for each frequency band filtered according to the frequency band by inputting the vibration signal to at least one filter, obtaining reconstruction signals corresponding to each defined frequency band from each signal reconstruction model by inputting the vibration signal for each frequency band to the signal reconstruction model corresponding to a frequency band, determining a reconstruction error value showing a difference between the vibration signal for each frequency band and the reconstruction signal corresponding to each frequency band, and determining the anomaly of the equipment based on an error value determined for each frequency band and a threshold value determined for each frequency band.

The determining of the anomaly of the equipment may include, when at least one of the reconstruction error value determined for each frequency band is greater than a corresponding threshold value, determining that there is the anomaly in the equipment.

The determining of the anomaly of the equipment may include, when the reconstruction error value determined for each frequency band is less than or equal to a corresponding threshold value, determining that the equipment is in a normal state.

The determining of the reconstruction error value may include determining the reconstruction error value based on at least one of an average value of differences between the vibration signal for each frequency band and the reconstruction signal corresponding to each frequency band, an average value of squares of the differences, and a square root value of the average value of the squares of the differences.

The method may further include, as a result of comparing the reconstruction error value determined for each frequency band with the threshold value determined for each frequency band, when a frequency band in which the reconstruction error value is greater than a corresponding threshold value is detected, estimating an anomaly type based on the detected frequency band.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating diagnosis of abnormality of equipment using a vibration signal of a time domain according to an embodiment;

FIG. 2 is a block diagram illustrating components of a training apparatus according to an embodiment;

FIG. 3 is a block diagram illustrating components of an abnormality diagnosis apparatus according to an embodiment;

FIG. 4 is a diagram illustrating filtering a vibration signal of a time domain according to an embodiment;

FIG. 5 is a diagram illustrating determining a reconstruction error value using a reconstruction signal according to an embodiment;

FIG. 6 is a diagram illustrating determining a threshold value by a training apparatus according to an embodiment;

FIG. 7 is a flowchart illustrating diagnosis of abnormality of equipment by an abnormality diagnosis apparatus according to an embodiment;

FIG. 8 is a diagram illustrating estimating an anomaly type of equipment for each frequency band by an abnormality diagnosis apparatus according to an embodiment;

FIG. 9 is a flowchart illustrating operations of a training method according to an embodiment;

FIG. 10 is a flowchart illustrating operations of an abnormality diagnosis method according to an embodiment;

FIG. 11 is a block diagram illustrating a training apparatus according to an embodiment; and

FIG. 12 is a block diagram illustrating an abnormality diagnosis apparatus according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, or similarly, the second component may be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

The term “unit” used herein may refer to a software or hardware component, such as a field-programmable gate array (FPGA) or an ASIC, and the “unit” performs predefined functions. However, the term “unit” is not limited to software or hardware. A “unit” may be configured to be in an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, the “unit” may include one or more processors.

Hereinafter, embodiments will be described in detail with reference to the accompanying drawings. When describing the embodiments with reference to the accompanying drawings, like reference numerals refer to like elements and a repeated description related thereto will be omitted.

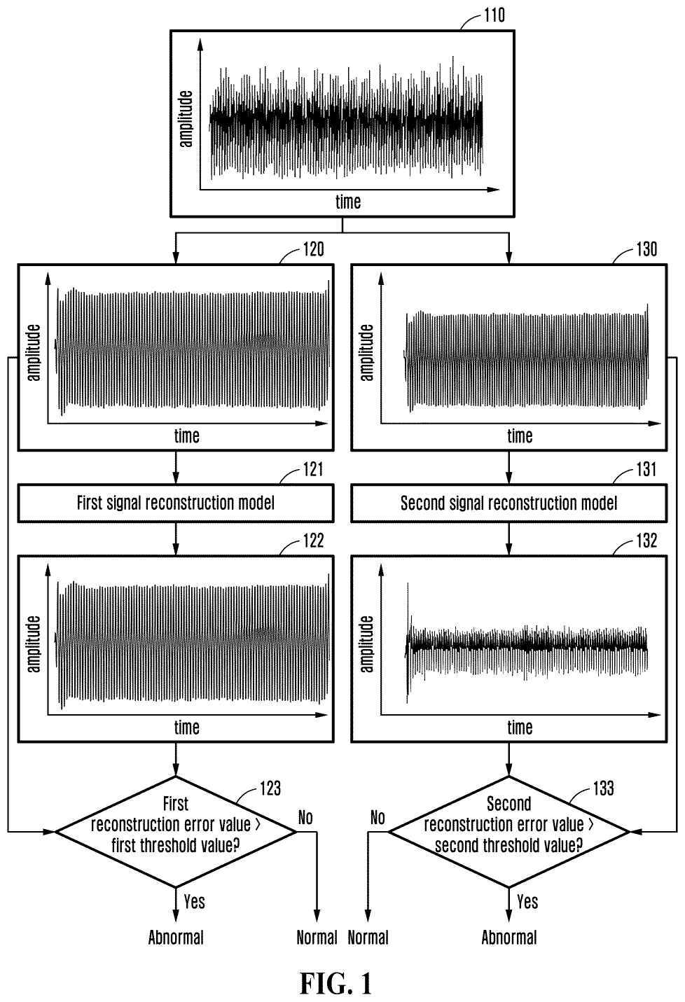

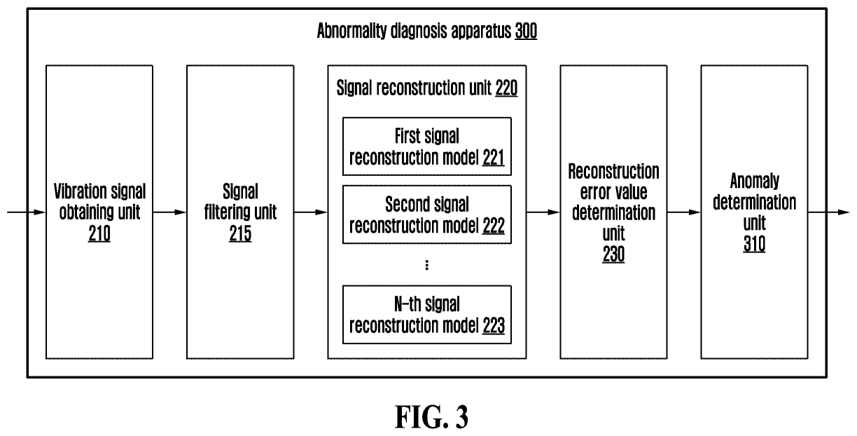

FIG. 1 is a diagram illustrating diagnosis of abnormality of equipment using a vibration signal of a time domain according to an embodiment. An abnormality diagnosis apparatus (e.g., an abnormality diagnosis apparatus 300 of FIG. 3) may determine an anomaly of equipment based on an artificial intelligence (AI) model (e.g., signal reconstruction models 221, 222, and 223 of FIG. 3), a reconstruction error value, and a threshold value.

Referring to FIG. 1, the abnormality diagnosis apparatus may obtain a vibration signal through a sensor (e.g., a vibration signal detection sensor). The abnormality diagnosis apparatus may determine an anomaly of equipment using a vibration signal generated in the equipment. The vibration signal used to determine the anomaly of the equipment may include a vibration signal of a time domain. The abnormality diagnosis apparatus according to an embodiment may periodically obtain vibration signals through a sensor. For example, the abnormality diagnosis apparatus may periodically obtain vibration signals from the equipment through a vibration sensor. A graph 110 is a graph of periodic vibration signals obtained by the abnormality diagnosis apparatus through the vibration sensor. The graph 110 is a vibration graph of the time domain and is a graph in which vibration signals of one or more frequency bands are combined.

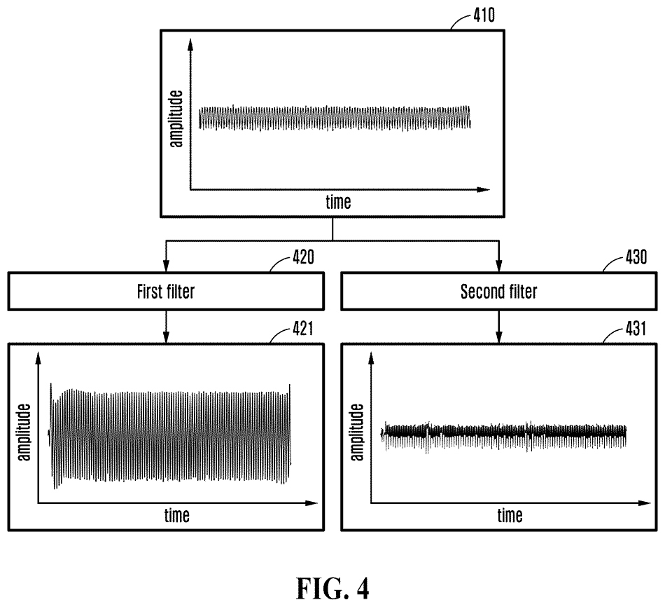

The abnormality diagnosis apparatus may filter the vibration signal of the time domain by frequency band. The abnormality diagnosis apparatus may input the vibration signal to one or more filters to obtain a vibration signal of the time domain for each defined frequency band from the filters. For example, the abnormality diagnosis apparatus may input the vibration signal of the graph 110 to filters to obtain a vibration signal of the time domain in a first frequency band and a vibration signal of the time domain in a second frequency band. A graph 120 is a graph showing vibration signals of the time domain in the first frequency band, and a graph 130 is a graph showing vibration signals of the time domain in the second frequency band. Various filters may be used to filter the vibration signals and will be described in more detail with reference to FIG. 4.

The abnormality diagnosis apparatus according to an embodiment may input the vibration signal of the time domain filtered for each frequency band to a corresponding signal reconstruction model. For example, the abnormality diagnosis apparatus may input the vibration signal of the time domain in the first frequency band of the graph 120 to a first signal reconstruction model 121, and input the vibration signal of the time domain in the second frequency band to a second signal reconstruction model 131.

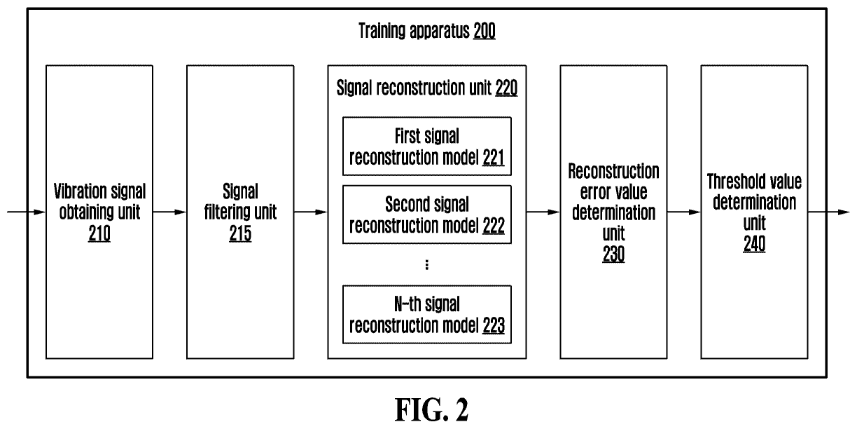

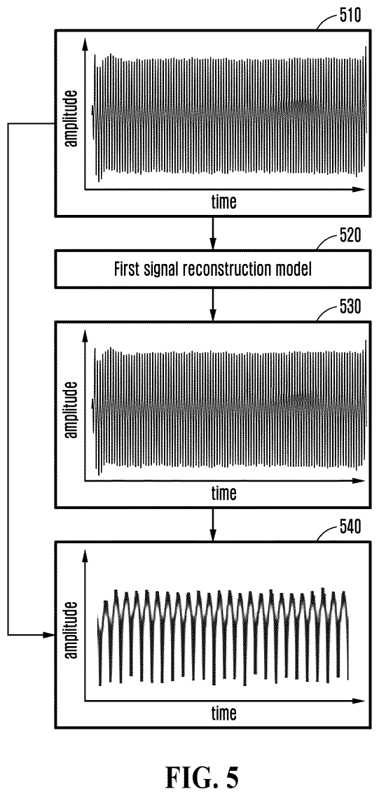

The signal reconstruction models 121 and 131 according to an embodiment may be an AI model trained through unsupervised learning. The signal reconstruction models 121 and 131 may be AI models trained through unsupervised learning by a training apparatus (e.g., a training apparatus 200 of FIG. 2). The signal reconstruction models 121 and 131 will be described in more detail with reference to FIG. 2. The abnormality diagnosis apparatus may obtain reconstruction signals corresponding to the input vibration signal from each signal reconstruction model using the vibration signal of the time domain as an input. For example, the abnormality diagnosis apparatus may obtain a reconstruction signal in the first frequency band from the first signal reconstruction model 121, and obtain a reconstruction signal in the second frequency band from the second signal reconstruction model 131. A graph 122 is a graph showing the reconstruction signal in the first frequency band from the first signal reconstruction model 121, and a graph 132 is a graph showing the reconstruction signal in the second frequency band from the second signal reconstruction model 131. The abnormality diagnosis apparatus generating the reconstruction signal will be described in more detail with reference to FIG. 5.

The abnormality diagnosis apparatus may determine the anomaly of the equipment by comparing a reconstruction error value and threshold values for each frequency band. The abnormality diagnosis apparatus may determine the anomaly of the equipment based on the reconstruction error value for each frequency and the threshold values for each frequency. For example, the abnormality diagnosis apparatus may determine that the equipment is abnormal in the first frequency band when a first reconstruction error value is greater than a first threshold value in the first frequency band (in case of “YES” in operation 123), and determine that the equipment is normal in the first frequency band when the first reconstruction error value is less than or equal to the first threshold value (in case of “NO” in operation 123). The abnormality diagnosis apparatus may determine that the equipment is abnormal in the second frequency band when a second reconstruction error value is greater than a second threshold value in the second frequency band (in case of “YES” in operation 133), and determine that the equipment is normal in the second frequency band when the second reconstruction error value is less than or equal to the second threshold value (in case of “NO” in operation 133).

FIG. 2 is a block diagram illustrating components of a training apparatus according to an embodiment.

Referring to FIG. 2, the training apparatus 200 may include a vibration signal obtaining unit 210, a signal filtering unit 215, a signal reconstruction unit 220, a reconstruction error value determination unit 230, and a threshold value determination unit 240. The training apparatus 200 may include a processor (not shown) for operating the vibration signal obtaining unit 210, the signal filtering unit 215, the signal reconstruction unit 220, the reconstruction error value determination unit 230, and the threshold value determination unit 240, and a memory for storing instructions executable by the processor (not shown).

The vibration signal obtaining unit 210 may obtain a vibration signal of a time domain obtained by measuring a vibration that occurs when the equipment is operating normally through a vibration sensor. The vibration sensor according to an embodiment may include a vibration sensor such as a micro-electro mechanical system (MEMS), an integrated electronics piezo-electric (IEPE) sensor, etc. A measurement time range of the vibration signal measured through the vibration sensor may vary depending on the specifications of the sensor and an environment for collecting the vibration signal. The vibration signal measured by the vibration sensor may be visualized in the time domain through a graph.

The signal filtering unit 215 may obtain the vibration signal for each frequency band from the filter. The signal filtering unit 215 may obtain the vibration signal for each frequency band by inputting the vibration signal to one or more filters. For example, the signal filtering unit 215 may obtain the vibration signal for each frequency band by inputting the vibration signal to a plurality of band pass filters (BPFs).

The signal reconstruction unit 220 may train signal reconstruction models 221, 222, and 223 corresponding to each of defined frequency bands using the vibration signal for each frequency band. The signal reconstruction unit 220 according to an embodiment may train (e.g., unsupervised learning) the signal reconstruction model using the vibration signal measured in the equipment in a normal state as training data. The signal reconstruction unit 220 may include a plurality of signal reconstruction models (e.g., a first signal reconstruction model 221, a second signal reconstruction model 222, and a third signal reconstruction model 223). The first signal reconstruction model 221 may correspond to the first signal reconstruction model 121 of FIG. 1, and the second signal reconstruction model 222 may correspond to the second signal reconstruction model 131 of FIG. 1.

The signal reconstruction unit 220 according to an embodiment may train the signal reconstruction models 221, 222, and 223 through unsupervised learning. For example, the signal reconstruction unit 220 may train the signal reconstruction models 221, 222, and 223 through unsupervised learning using the vibration signal of the time domain measured in the equipment in a normal state. The signal reconstruction models 221, 222, and 223 trained by the signal reconstruction unit 220 through unsupervised learning may include at least one of an autoencoder, a stacked autoencoder, a long short-term memory autoencoder (LSTM autoencoder), and a convolutional autoencoder model.

The signal reconstruction unit 220 according to an embodiment may obtain reconstruction signals corresponding to each frequency band from the signal reconstruction models 221, 222, and 223. For example, when the signal reconstruction unit 220 inputs the vibration signal of the time domain measured in the equipment in a normal state to the signal reconstruction models 221, 222, and 223, the signal reconstruction unit 220 may obtain a reconstruction signal similar to the vibration signal of the time domain for each frequency band from the signal reconstruction models 221, 222, and 223.

The reconstruction error value determination unit 230 may determine a reconstruction error value for the reconstruction signal. The reconstruction error value represents a difference between the vibration signal for each frequency band and the reconstruction signal corresponding to each frequency band. The reconstruction error value determination unit 230 according to an embodiment may determine an error value for each frequency band based on the difference between the vibration signal for each frequency band and the reconstruction signal corresponding to each frequency band. For example, the reconstruction error value determination unit 230 may determine the reconstruction error value based on at least one of an average value of differences between the vibration signal for each frequency band and the reconstruction signal corresponding to each frequency band, an average value of squares of the differences between the vibration signal for each frequency band and the reconstruction signal corresponding to each frequency band, and a square root value of the average value of the squares of the differences between the vibration signal for each frequency band and the reconstruction signal corresponding to each frequency band. The reconstruction error value will be described in more detail with reference to FIG. 5.

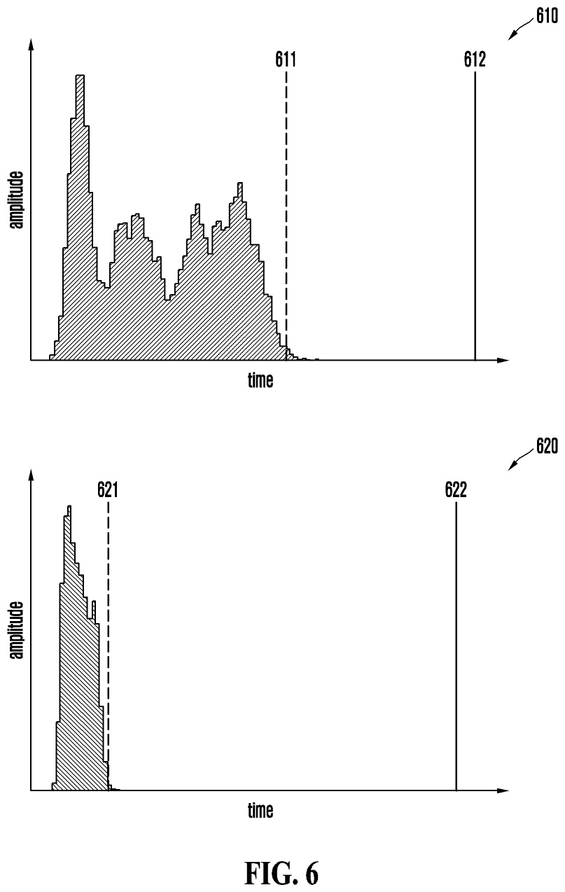

The threshold value determination unit 240 may determine a threshold value for anomaly detection for each defined frequency band. The threshold value determination unit 240 may determine a threshold value based on the reconstruction error value determined for each defined frequency band. For example, the threshold value determination unit 240 may determine the threshold value based on the three-sigma rule or a maximum value of the reconstruction error value for each frequency band. The threshold value determination unit 240 determining the threshold value will be described in more detail with reference to FIG. 6.

FIG. 3 is a block diagram illustrating components of an abnormality diagnosis apparatus according to an embodiment.

Referring to FIG. 3, an abnormality diagnosis apparatus 300 may include the vibration signal obtaining unit 210, the signal filtering unit 215, the signal reconstruction unit 220, the reconstruction error value determination unit 230, and an anomaly determination unit 310. The abnormality diagnosis apparatus 300 may include a processor (not shown) for operating the vibration signal obtaining unit 210, the signal filtering unit 215, the signal reconstruction unit 220, the reconstruction error value determination unit 230, and the anomaly determination unit 310, and a memory for storing instructions executable by the processor (not shown).

The vibration signal obtaining unit 210, the signal filtering unit 215, the signal reconstruction unit 220, and the reconstruction error value determination unit 230 have been described above with reference to FIG. 2, and therefore, the repeated description thereof will be omitted.

The anomaly determination unit 310 may determine an anomaly of equipment. The anomaly determination unit 310 may determine the anomaly of the equipment based on an error value determined for each defined frequency band and a threshold value determined for each defined frequency band.

The anomaly determination unit 310 according to an embodiment may determine the anomaly of the equipment based on the anomaly for each frequency. For example, the anomaly determination unit 310 may determine whether the anomaly of the entire equipment by performing a logic operation (e.g., OR logic operation (normal (1), abnormal (0))) based on the result of determining the anomaly in the first frequency band and the result of determining the anomaly in the second frequency band. When a result value of the anomaly in the first frequency band is 1 (normal) and a result value of the anomaly in the second frequency band is 1 (normal), the anomaly determination unit 310 may determine that there is no anomaly in the entire equipment because the OR logic operation value is 1.

The anomaly determination unit 310 according to an embodiment may determine whether there is an anomaly in the entire equipment based on N (a natural number greater than or equal to 2) filters and N signal reconstruction models. The number of combinations of result values for each frequency based in the defined N frequency domains is 2\hat{ }N. The anomaly determination unit 310 may determine that there is no anomaly in the entire equipment when all of the result values in the N frequency domains are 1 (e.g., when the OR logic operation value is 1).

FIG. 4 is a diagram illustrating filtering a vibration signal of a time domain according to an embodiment.

Referring to FIG. 4, a signal filtering unit (e.g., the signal filtering unit 215 of FIG. 2) of the abnormality diagnosis apparatus (e.g., the abnormality diagnosis apparatus 300 of FIG. 3) may filter the vibration signal in the time domain by defined frequency band. The signal filtering unit of the abnormality diagnosis apparatus may include one or more filters for filtering the vibration signal. The abnormality diagnosis apparatus may obtain a vibration signal of the time domain for each defined frequency band from a filter for each band (e.g., a first filter 420 and a second filter 430). The signal filtering (or frequency filtering) may pass or suppress a signal of a specific frequency band using the filter. The filter may include a band pass filter (BPF), a high pass filter (HPF), a low pass filter (LPF), and a band-stop filter (BSF). The BPF is a filter that passes only signals in a specific frequency band, and the HPF is a filter that passes only signals at a frequency equal to or higher than the specific frequency. The LPF is a filter that passes only signals at a frequency equal to or lower than the specific frequency, and the BSF is a filter that blocks only signals in the specific frequency band.

A graph 410 is a graph showing a vibration signal of a time domain obtained through a vibration sensor. The signal filtering unit according to an embodiment may obtain a vibration signal for each defined frequency band using a BPF. For example, the signal filtering unit may obtain a vibration signal of the first frequency band by using a first filter 420 (e.g., a first BPF) that passes only frequency signals of the first frequency band (e.g., a frequency of 124 Hz or lower), and obtain a vibration signal of the second frequency band by using a second filter 430 (a second BPF) that passes only frequency signals of the second frequency band (e.g., a frequency higher than 124 Hz). A graph 421 is a graph showing a vibration signal of the first frequency band in the time domain, and a graph 431 is a graph showing a vibration signal of the second frequency band in the time domain.

The number of filters and the range of frequency bands passing through each filter may vary depending on an equipment operating environment and a frequency band of interest, and are not limited thereto.

FIG. 5 is a diagram illustrating determining a reconstruction error value using a reconstruction signal according to an embodiment.

Referring to FIG. 5, an abnormality diagnosis apparatus (e.g., the abnormality diagnosis apparatus 300 of FIG. 3) may determine a reconstruction error value based on a vibration signal and a reconstruction signal of the time domain. A generated reconstruction signal of a graph 530 is a result value output by inputting the vibration signal of the first frequency band of a graph 510 to a first signal reconstruction model 520. The reconstruction signal output from the first signal reconstruction model 520 may output a reconstruction signal similar to an input vibration signal as the input vibration signal is similar to the vibration signal used for the training of the first signal reconstruction model 520. The first signal reconstruction model 520 may correspond to the first signal reconstruction model 121 of FIG. 1 and/or the first signal reconstruction model 221 of FIG. 2. A graph 540 is a graph showing a vibration signal of the first frequency band and a reconstruction signal corresponding to the vibration signal of the first frequency band.

An error value determination unit of the abnormality diagnosis apparatus according to an embodiment may determine a reconstruction error value based on a difference between the vibration signal of the first frequency band of the graph 540 and the reconstruction signal corresponding to the vibration signal of the first frequency band. For example, the error value determination unit of the abnormality diagnosis apparatus may determine the reconstruction error value based on at least one of an average value of differences between the vibration signal for each frequency band and the reconstruction signal corresponding to each frequency band, an average value of squares of the differences between the vibration signal for each frequency band and the reconstruction signal corresponding to each frequency band, and a square root value of the average value of the squares of the differences between the vibration signal for each frequency band and the reconstruction signal corresponding to each frequency band.

The average value (mean absolute error (MAE)) of differences between the vibration signal for each frequency band and the reconstruction signal corresponding to each frequency band may be expressed by Mathematical Expression 1 below.

$$\frac{1}{n} {\sum }_{i = 1}^{n} \vert {X}_{i} - {X}_{i}^{′} \vert \qquad [ Mathematical Expression 1 ]$$

The average value (mean squared error (MSE)) of squares of the differences between the vibration signal for each frequency band and the reconstruction signal corresponding to each frequency band may be expressed by Mathematical Expression 2 below.

$$\frac{1}{n} {\sum }_{i = 1}^{n} {( {X}_{i} - {X}_{i}^{′} )}^{2} \qquad [ Mathematical Expression 2 ]$$

The square root value (root mean squared error (RMSE)) of the average value of the squares of the differences between the vibration signal for each frequency band and the reconstruction signal corresponding to each frequency band may be expressed by Mathematical Expression 3 below.

$$\frac{1}{n} {\sum }_{i = 1}^{n} {( {X}_{i} - {X}_{i}^{′} )}^{2} \qquad [ Mathematical Expression 3 ]$$

In Mathematical Expressions 1 to 3, n is the number of vibration signals, Xᵢ is intensity of an i-th vibration signal, and

$${X}_{i}^{′}$$

is intensity of an i-th reconstruction signal.

FIG. 6 is a diagram illustrating determining a threshold value by a training apparatus according to an embodiment.

Referring to FIG. 6, a reconstruction error value determination unit (e.g., the reconstruction error value determination unit 230 of FIG. 3) of an abnormality diagnosis apparatus (e.g., the abnormality diagnosis apparatus 300 of FIG. 3) may determine a threshold value using a reconstruction signal. For example, the reconstruction error value determination unit may determine the threshold value based on the three-sigma rule or a maximum value of the reconstruction value. The method of determining the threshold value may be determined differently depending on the equipment operating environment. When there are N frequency-divided regions according to an embodiment, the reconstruction error value determination unit may obtain a threshold value in each frequency band for each of the N reconstruction signals.

A threshold value determination unit (e.g., the threshold value determination unit 240 of FIG. 2) according to an embodiment may determine the threshold value for each frequency band (e.g., a first frequency band (a frequency band equal to or lower than 124 Hz) and a second frequency band (a frequency band exceeding 124 Hz)). For example, a graph 610 is a graph showing a reconstruction error value in the first frequency band. The threshold value determination unit may determine a maximum value 611 of the reconstruction error value for the first frequency band or a value 612 that is separated from the average value of the reconstruction error value by three times the standard deviation of the reconstruction error value, as the first threshold value. A graph 620 shows the reconstruction error value in the second frequency band. The threshold value determination unit may determine a maximum value 621 of the reconstruction error value for the second frequency band or a value 622 that is separated from the average value of the reconstruction error value by three times the standard deviation of the reconstruction error value, as the second threshold value.

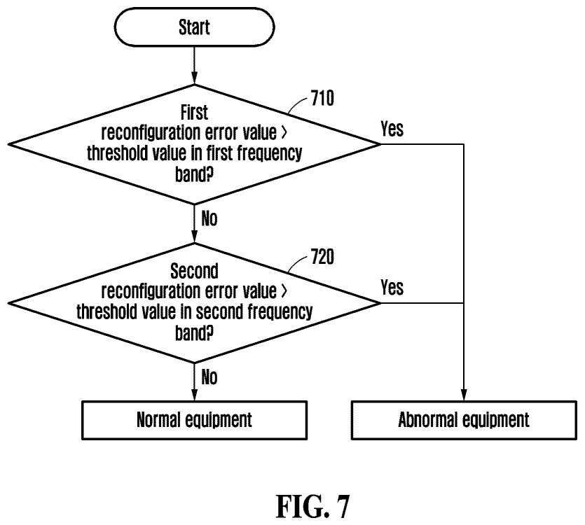

FIG. 7 is a flowchart illustrating diagnosis of abnormality of equipment by an abnormality diagnosis apparatus according to an embodiment.

Referring to FIG. 7, an abnormality diagnosis apparatus (e.g., the abnormality diagnosis apparatus 300 of FIG. 3) may determine an anomaly of the entire equipment based on an error value and a threshold value for each frequency. The error value and the threshold value for each frequency have been described above with reference to FIGS. 5 and 6, and therefore, the repeated description thereof will be omitted.

The abnormality diagnosis apparatus according to an embodiment may determine that there is the anomaly in the equipment when at least one of reconstruction error values determined for each frequency band is greater than a corresponding threshold value. For example, when a first reconstruction error value is greater than a threshold value of the first frequency band (“YES” in operation 710) or when a second reconstruction error value is greater than a threshold value of the second frequency band (“YES” in operation 720), the abnormality diagnosis apparatus may determine that the equipment is abnormal. When the first reconstruction error value is less than or equal to the threshold value of the first frequency band (“NO” in operation 710) and the second reconstruction error value is less than or equal to the threshold value of the second frequency band (“NO” in operation 720), the abnormality diagnosis apparatus may determine that the equipment is normal.

The abnormality diagnosis apparatus according to an embodiment may determine not only the anomaly of the entire equipment, but also determine whether the equipment is abnormal for each frequency band. The abnormality related to the first frequency band may be unbalancing and the abnormality related to the second frequency band may be misalignment. When the first reconstruction error value is less than or equal to the threshold value of the first frequency band and the second reconstruction error value is greater than the threshold value of the second frequency band, the abnormality diagnosis apparatus may determine that there is misalignment in the equipment.

In a case where there are N frequency bands according to an embodiment, the abnormality diagnosis apparatus may determine that the equipment is normal only when the error values of each frequency band are less than or equal to the threshold value corresponding to each frequency band.

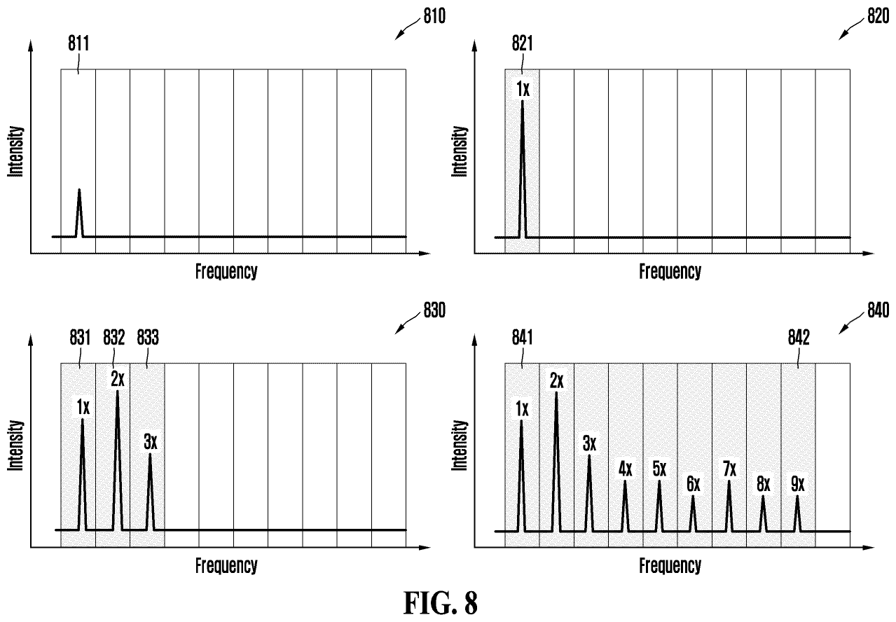

FIG. 8 is a diagram illustrating estimating an anomaly type of equipment for each frequency band by an abnormality diagnosis apparatus according to an embodiment.

Referring to FIG. 8, an abnormality diagnosis apparatus (e.g., the abnormality diagnosis apparatus 300 of FIG. 3) may compare a reconstruction error value determined for each frequency band with a threshold value determined for each frequency band. When a frequency band in which the reconstruction error value is greater than a corresponding threshold value is detected, the abnormality diagnosis apparatus may estimate an anomaly type (e.g., an anomaly type 1x) based on the detected frequency band.

The abnormality diagnosis apparatus according to an embodiment may compare the reconstruction error value determined for each frequency band with the threshold value determined for each frequency band. As a result of comparing the reconstruction error value with the threshold value, when a frequency band in which the reconstruction error value is greater than a threshold value is detected, the abnormality diagnosis apparatus may estimate the anomaly type based on the detected frequency band. When the reconstruction error value is less than or equal to the threshold value in the frequency band of a graph 810 and no vibration frequency signal is detected in other frequency bands, the abnormality diagnosis apparatus may determine that the equipment is in a normal state. When the reconstruction error value in a frequency band 821 of a graph 820 is greater than the threshold value, the abnormality diagnosis apparatus may estimate the anomaly type (e.g., 1X type) of the equipment related to the frequency band 821. When the reconstruction error value is greater than each threshold value in each of frequency bands 831, 832, and 833 of a graph 830, the abnormality diagnosis apparatus may estimate the anomaly type (e.g., 1X type, 2X type, or 3X type) of the equipment related to each of the frequency bands 831, 832, and 833. When each reconstruction error value corresponding to a frequency band 842 in a frequency band 841 of a graph 840 is greater than each threshold value, the abnormality diagnosis apparatus may estimate the anomaly type (e.g., 1X type, 2X type, 3X type, 4X type, 5X type, 6X type, 7X type, 8X type, or 9X type) of the equipment related to each frequency band.

The abnormality diagnosis apparatus may estimate the type of anomaly occurring in the equipment by using an anomaly amplitude occurring in a specific frequency range. Since the vibration signal generated in the equipment shows a high amplitude in the specific frequency range depending on various types of abnormality, the abnormality diagnosis apparatus may perform effective equipment abnormality diagnosis.

The abnormality diagnosis apparatus may improve anomaly detection performance (a true positive rate (TPR)) by determining the anomaly of the equipment by using the generation of anomaly amplitude in the specific frequency range. For example, the abnormality diagnosis apparatus may estimate equipment anomaly such as unbalancing, misalignment, looseness, and bearing faults using a rotating machine simulator and an IEPE type vibration sensor.

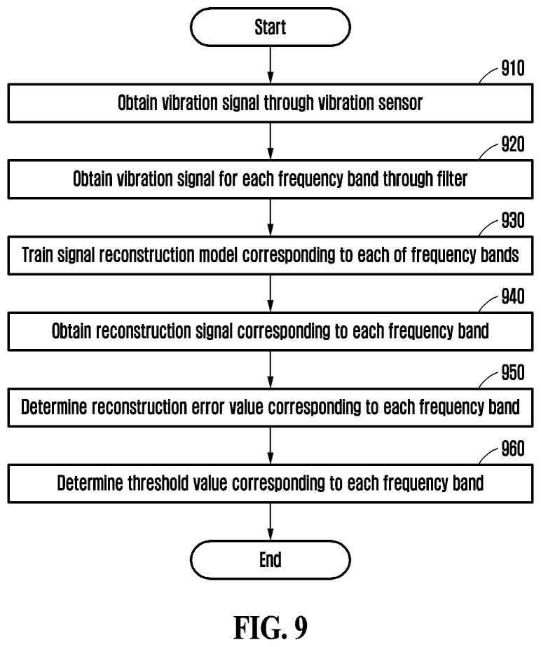

FIG. 9 is a flowchart illustrating operations of a training method according to an embodiment.

The operations of the training method of training a signal reconstruction model may be performed by a training apparatus (e.g., the training apparatus 200 of FIG. 2).

In operation 910, the training apparatus may obtain a vibration signal through a vibration sensor. The training apparatus may obtain a vibration signal of a time domain obtained by measuring a vibration that occurs when equipment is operating normally through a vibration sensor. For example, the training apparatus may obtain the vibration signal generated from the equipment through a MEMS sensor.

In operation 920, the training apparatus may obtain a vibration signal for each frequency band through a filter. The training apparatus may obtain a vibration signal for each frequency band filtered according to defined frequency bands by inputting the vibration signal to at least one filter. For example, the training apparatus may obtain vibration signals for each frequency band from a plurality of BPFs that have input the vibration signals.

In operation 930, the training apparatus may train a signal reconstruction model corresponding to each of the frequency bands. The training apparatus may train a signal reconstruction model corresponding to each of the defined frequency bands using the vibration signal for each frequency band. For example, the training apparatus may train signal reconstruction models through unsupervised learning by using the vibration signal for each frequency band of the equipment in a normal state. The signal reconstruction model according to an embodiment may include at least one of an autoencoder, a stacked autoencoder, a LSTM autoencoder, and a convolutional autoencoder model.

In operation 940, the training apparatus may obtain a reconstruction signal corresponding to each frequency domain. The training apparatus may obtain a reconstruction signal corresponding to each frequency band through the trained signal reconstruction model for each frequency band.

In operation 950, the training apparatus may determine a reconstruction error value corresponding to each frequency band. The training apparatus may determine a reconstruction error value showing a difference between the vibration signal for each frequency band and the reconstruction signal corresponding to each frequency band. For example, the training apparatus may determine the reconstruction error value based on at least one of an average value of differences between the vibration signal for each frequency band and the reconstruction signal corresponding to each frequency band, an average value of squares of the differences between the vibration signal for each frequency band and the reconstruction signal corresponding to each frequency band, and a square root value of the average value of the squares of the differences between the vibration signal for each frequency band and the reconstruction signal corresponding to each frequency band.

In operation 960, the training apparatus may determine a threshold value corresponding to each frequency band. The training apparatus may determine a threshold value for anomaly detection corresponding to each of the defined frequency bands based on the reconstruction error value determined for each of the defined frequency bands. The training apparatus according to an embodiment may determine a threshold value of the reconstruction error value based on the three-sigma rule or a maximum value of the reconstruction error value for each frequency band. The three-sigma rule determines a value that is separated from the average value of the reconstruction error value by three times the standard deviation of the reconstruction error value, as a threshold value.

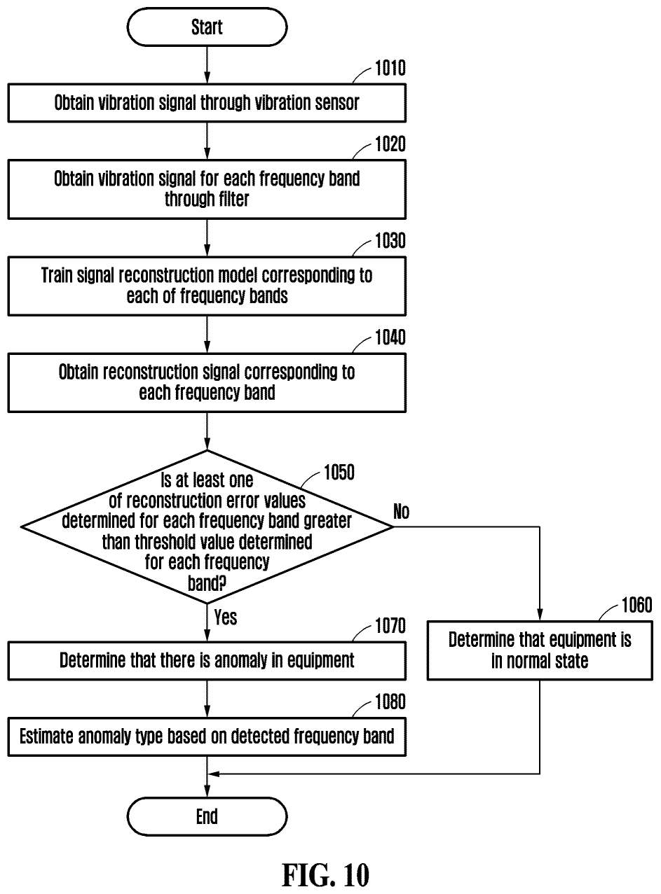

FIG. 10 is a flowchart illustrating operations of an abnormality diagnosis method according to an embodiment.

The operations of the abnormality diagnosis method of diagnosing the anomaly of the equipment may be performed by an abnormality diagnosis apparatus (e.g., the abnormality diagnosis apparatus 300 of FIG. 3).

In operation 1010, the abnormality diagnosis apparatus may obtain a vibration signal through a vibration sensor. The vibration signal obtained through the vibration sensor may include a vibration signal of a time domain. For example, the abnormality diagnosis apparatus may obtain a vibration signal of the time domain through an IEPE vibration sensor.

In operation 1020, the abnormality diagnosis apparatus may obtain the vibration signal for each frequency band through a filter. The abnormality diagnosis apparatus may obtain the vibration signal for each frequency band filtered according to the frequency band by inputting the vibration signal of the time domain to at least one or more filters. For example, the abnormality diagnosis apparatus may obtain a vibration signal in a band higher than 124 Hz and a vibration signal in a band lower than or equal to 124 Hz by inputting the vibration signal of the time domain to a HPF (a cut-off frequency of 124 Hz) and an LPF (a cut-off frequency of 124 Hz).

In operation 1030, the abnormality diagnosis apparatus may obtain a reconstruction signal from each signal reconstruction model. For example, the abnormality diagnosis apparatus may obtain reconstruction signals corresponding to each defined frequency band from each signal reconstruction model by inputting the vibration signal for each frequency band to the signal reconstruction model corresponding to a frequency band. The signal reconstruction models according to an embodiment may include at least one of an autoencoder, a stacked autoencoder, an LSTM autoencoder, and a convolutional autoencoder.

In operation 1040, the abnormality diagnosis apparatus may determine the reconstruction error value for each frequency band. For example, an abnormality diagnosis apparatus may determine a reconstruction error value showing a difference between the vibration signal for each frequency band and the reconstruction signal corresponding to each frequency band. The abnormality diagnosis apparatus according to an embodiment may determine the reconstruction error value based on at least one of an average value of differences between the vibration signal for each frequency band and the reconstruction signal corresponding to each frequency band, an average value of squares of the differences between the vibration signal for each frequency band and the reconstruction signal corresponding to each frequency band, and a square root value of the average value of the squares of the differences between the vibration signal for each frequency band and the reconstruction signal corresponding to each frequency band.

The abnormality diagnosis apparatus may determine an anomaly of equipment based on an error value determined for each frequency band and a threshold value determined for each frequency band. In operation 1060, when at least one of the reconstruction error values determined for each frequency band is less than or equal to the threshold value determined for each frequency band (in case of “NO” in operation 1050), the abnormality diagnosis apparatus may determine that the equipment is in a normal state.

In operation 1070, when at least one of the reconstruction error values determined for each frequency band is greater than the threshold value determined for each frequency band (in case of “YES” in operation 1050), the abnormality diagnosis apparatus may determine that the equipment is in an abnormal state. In operation 1080, when the abnormality diagnosis apparatus determines that the equipment is in an abnormal state, the abnormality diagnosis apparatus may estimate an anomaly type based on the detected frequency band. As a result of comparing the reconstruction error value determined for each frequency band with the threshold value determined for each frequency band, when a frequency band in which the reconstruction error value is greater than a corresponding threshold value is detected, the abnormality diagnosis apparatus may estimate the anomaly type based on the detected frequency band. The type of anomaly that may occur in the first frequency band may be 1X type, and the type of anomaly that may occur in the second frequency band is 2X type. When the reconstruction error value in the first frequency band is greater than the corresponding threshold value, the abnormality diagnosis apparatus may determine that the equipment may have abnormality of 1X type.

The abnormality diagnosis apparatus may obtain the vibration signal of the time domain for each frequency band by using a BPF, a HPF, an LPF, or the like. The abnormality diagnosis apparatus may estimate occurrence of an anomaly corresponding to each frequency band by inputting the vibration signal for each frequency band to the signal reconstruction model for each frequency band. The abnormality diagnosis apparatus may determine the anomaly of the entire equipment based on the estimated anomaly type of the equipment based on the vibration signal for each frequency band.

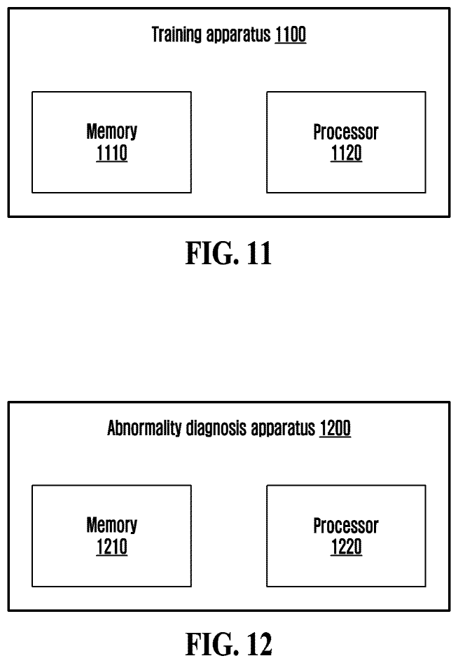

FIG. 11 is a block diagram illustrating a training apparatus according to an embodiment.

Referring to FIG. 11, a training apparatus 1100 may include a memory 1110 and a processor 1120. The training apparatus 1100 of FIG. 11 may correspond to the training apparatus 200 of FIG. 2. The operations of the vibration signal obtaining unit 210, the signal filtering unit 215, the signal reconstruction unit 220, the reconstruction error value determination unit 230, and the threshold value determination unit 240 of FIG. 2 may be performed by the processor 1120.

The memory 1110 may store instructions that may be performed by the processor 1120. The memory 1110 may store instructions executable by the processor 1120. The instructions executable by the processor 1120, when executed by the processor 1120, may cause the processor 1120 to perform the training method of the signal reconstruction unit 220. The memory 1110 may be integrated with the processor 1120. For example, random-access memory (RAM) or flash memory may be arranged in an integrated circuit (IC) microprocessor. The memory 1110 may include a separate device such as an external disk drive, a storage array, or other storage devices that may be used by any database system. The memory 1110 and the processor 1120 may be operatively integrated or may allow the processor 1120 to read a file stored in the memory 1110 by communicating with each other via an I/O port or a network connection. The memory 1110 may be a non-transitory computer-readable storage medium that stores instructions and when the instructions are executed by the processor 1120, the instructions stored in the memory 1110 may prompt at least one processor 1120 to execute the training method of the training apparatus 1100.

Examples of a non-transitory computer-readable storage medium may include read-only memory (ROM), random access programmable read-only memory (PROM), electrically erasable programmable read-only memory (EEPROM), RAM, dynamic RAM (DRAM), static RAM (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, BLU-RAY or optical disk storage, hard disk drive (HDD), solid state drive (SSD), card memory (e.g., a multimedia card, a secure digital (SD) card, or an extreme digital (XD) card), magnetic tapes, floppy disks, magneto-optical data storage devices, optical data storage devices, hard disks, solid-state disks, and any other device.

For example, the processor 1120 may execute the instructions stored in the memory 1110. The processor 1120 may include a CPU, a graphics processing unit (GPU), a neural network processing unit (NPU), a media processing unit (MPU), a data processing unit (DPU), a vision processing unit (VPU), a video processor, an image processor, a display processor, a microprocessor, a processor core, a multi-core processor, an application-specific integrated circuit (ASIC), a field programmable gate array (FPGA), or any combination thereof.

The processor 1120 may obtain a vibration signal of a time domain obtained by measuring a vibration that occurs when equipment is operating normally through a vibration sensor, and obtain a vibration signal for each frequency band filtered according to defined frequency bands by inputting the vibration signal to at least one filter. The processor 1120 may train a signal reconstruction model corresponding to each of the defined frequency bands using the vibration signal for each frequency band, and obtain a reconstruction signal corresponding to each frequency band through the trained signal reconstruction model for each frequency band. The processor 1120 may determine a reconstruction error value showing a difference between the vibration signal for each frequency band and the reconstruction signal corresponding to each frequency band, and determine a threshold value for anomaly detection corresponding to each of the defined frequency bands based on the reconstruction error value determined for each of the defined frequency bands.

The processor 1120 may determine the reconstruction error value based on at least one of an average value of differences between the vibration signal for each frequency band and the reconstruction signal corresponding to each frequency band, an average value of squares of the differences, and a square root value of the average value of the squares of the differences, and the processor 1120 may determine a threshold value of the reconstruction error value based on the three-sigma rule or a maximum value of the reconstruction error value for each frequency band.

FIG. 12 is a block diagram illustrating an abnormality diagnosis apparatus according to an embodiment.

Referring to FIG. 12, an abnormality diagnosis apparatus 1200 may include a memory 1210 and a processor 1220. The abnormality diagnosis apparatus 1200 may correspond to the abnormality diagnosis apparatus 300 of FIG. 3. The operations of the vibration signal obtaining unit 210, the signal filtering unit 215, the signal reconstruction unit 220, the reconstruction error value determination unit 230, and the anomaly determination unit 310 of FIG. 3 may be performed by the processor 1220.

The memory 1210 may store instructions that may be performed by the processor 1220. The memory 1210 may store instructions executable by the processor 1220. When instructions executable by the processor 1220 are executed by the processor 1220, the memory 1210 may be integrated with the processor 1220. For example, RAM or flash memory may be arranged in an IC microprocessor. In addition, the memory 1210 may include a separate device such as an external disk drive, a storage array, or other storage devices that may be used by any database system. The memory 1210 and the processor 1220 may be operatively integrated or may allow the processor 1220 to read a file stored in the memory 1210 by communicating with each other via an I/O port or a network connection. The memory 1210 may be a non-transitory computer-readable storage medium that stores instructions and when the instructions are executed by the processor 1220, the instructions stored in the memory 1210 may prompt at least one processor 1220 to execute the abnormality diagnosis apparatus 1200.

Examples of a non-transitory computer-readable storage medium may include read-only memory (ROM), random access programmable read-only memory (PROM), electrically erasable programmable read-only memory (EEPROM), random-access memory (RAM), dynamic RAM (DRAM), static RAM (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, BLU-RAY or optical disk storage, hard disk drive (HDD), solid state drive (SSD), card memory (e.g., a multimedia card, a secure digital (SD) card, or an extreme digital (XD) card), magnetic tapes, floppy disks, magneto-optical data storage devices, optical data storage devices, hard disks, solid-state disks, and any other device.

The processor 1220 may execute instructions stored in the memory 1210. The processor 1220 may include a CPU, a GPU, a NPU, a MPU, a DPU, a VPU, a video processor, an image processor, a display processor, a microprocessor, a processor core, a multi-core processor, an ASIC, a FPGA, or any combination thereof.

The processor 1220 may obtain a vibration signal of a time domain obtained by measuring a vibration that occurs in equipment through a vibration sensor, and obtain a vibration signal for each frequency band filtered according to defined frequency bands by inputting the vibration signal to at least one filter. The processor 1220 may obtain reconstruction signals corresponding to each defined frequency band from each signal reconstruction model by inputting the vibration signal for each frequency band to the signal reconstruction model corresponding to a frequency band, and determine a reconstruction error value showing a difference between the vibration signal for each frequency band and the reconstruction signal corresponding to each frequency band, and determine the anomaly of the equipment based on an error value determined for each defined frequency band and a threshold value determined for each defined frequency band.

When at least one of the reconstruction error value determined for each frequency band is greater than a corresponding threshold value, the processor 1220 may determine that there is the anomaly in the equipment, and when the reconstruction error value determined for each frequency band is less than or equal to a corresponding threshold value, the processor 1220 may determine that the equipment is in a normal state.

The processor 1220 may determine the reconstruction error value based on at least one of an average value of differences between the vibration signal for each frequency band and the reconstruction signal corresponding to each frequency band, an average value of squares of the differences, and a square root value of the average value of the squares of the differences, and as a result of comparing the reconstruction error value determined for each frequency band with the threshold value determined for each frequency band, when a frequency band in which the reconstruction error value is greater than a corresponding threshold value is detected, estimate an anomaly type based on the detected frequency band.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. A training apparatus comprising:
a processor; and
a memory configured to store instructions executable by the processor,
wherein the instructions, when executed by the processor, cause the training apparatus to:
obtain a vibration signal of a time domain obtained by measuring a vibration that occurs when equipment is operating normally through a vibration sensor;
obtain a vibration signal for each frequency band filtered according to defined frequency bands by inputting the vibration signal to at least one filter;
train a signal reconstruction model corresponding to each of the defined frequency bands using the vibration signal for each frequency band;
obtain a reconstruction signal corresponding to each frequency band through the trained signal reconstruction model for each frequency band;
determine a reconstruction error value showing a difference between the vibration signal for each frequency band and the reconstruction signal corresponding to each frequency band; and
determine a threshold value for anomaly detection corresponding to each of the defined frequency bands based on the reconstruction error value determined for each of the defined frequency bands.

2. The training apparatus of claim 1, wherein the signal reconstruction model comprises at least one of an autoencoder, a stacked autoencoder, a long short-term memory (LSTM) autoencoder, and a convolutional autoencoder.

3. The training apparatus of claim 1, wherein the instructions, when executed by the processor, cause the training apparatus to:
determine the reconstruction error value based on at least one of an average value of differences between the vibration signal for each frequency band and the reconstruction signal corresponding to each frequency band, an average value of squares of the differences, and a square root value of the average value of the squares of the differences.

4. The training apparatus of claim 1, wherein the instructions, when executed by the processor, cause the training apparatus to:
determine a threshold value of the reconstruction error value based on the three-sigma rule or a maximum value of the reconstruction error value for each frequency band.

5. An abnormality diagnosis apparatus for diagnosing an anomaly of equipment using a signal reconstruction model, the abnormality diagnosis apparatus comprising:
a processor; and
a memory configured to store instructions executable by the processor,
wherein the instructions, when executed by the processor, cause the training apparatus to:
obtain a vibration signal of a time domain obtained by measuring a vibration that occurs in equipment through a vibration sensor;
obtain a vibration signal for each frequency band filtered according to each defined frequency band by inputting the vibration signal to at least one filter;
obtain reconstruction signals corresponding to each defined frequency band from each signal reconstruction model by inputting the vibration signal for each frequency band to the signal reconstruction model corresponding to a frequency band;
determine a reconstruction error value showing a difference between the vibration signal for each frequency band and the reconstruction signal corresponding to each frequency band; and
determine the anomaly of the equipment based on an error value determined for each defined frequency band and a threshold value determined for each defined frequency band.

6. The abnormality diagnosis apparatus of claim 5, wherein the instructions, when executed by the processor, cause the training apparatus to:
when at least one of the reconstruction error value determined for each frequency band is greater than a corresponding threshold value, determine that there is the anomaly in the equipment.

7. The abnormality diagnosis apparatus of claim 5, wherein the instructions, when executed by the processor, cause the training apparatus to:
when the reconstruction error value determined for each frequency band is less than or equal to a corresponding threshold value, determine that the equipment is in a normal state.

8. The abnormality diagnosis apparatus of claim 5, wherein the signal reconstruction model comprises at least one of an autoencoder, a stacked autoencoder, a long short-term memory (LSTM) autoencoder, and a convolutional autoencoder.

9. The abnormality diagnosis apparatus of claim 5, wherein the instructions, when executed by the processor, cause the training apparatus to:
determine the reconstruction error value based on at least one of an average value of differences between the vibration signal for each frequency band and the reconstruction signal corresponding to each frequency band, an average value of squares of the differences, and a square root value of the average value of the squares of the differences.

10. The abnormality diagnosis apparatus of claim 5, wherein the instructions, when executed by the processor, cause the training apparatus to:
as a result of comparing the reconstruction error value determined for each frequency band with the threshold value determined for each frequency band, when a frequency band in which the reconstruction error value is greater than a corresponding threshold value is detected, estimate an anomaly type based on the detected frequency band.

11. A training method of training a signal reconstruction model by a training apparatus, the training method comprising:
obtaining a vibration signal of a time domain obtained by measuring a vibration that occurs when equipment is operating normally through a vibration sensor;
obtaining a vibration signal for each frequency band filtered according to defined frequency bands by inputting the vibration signal to at least one filter;
training a signal reconstruction model corresponding to each of the defined frequency bands using the vibration signal for each frequency band;
obtaining a reconstruction signal corresponding to each frequency band through the trained signal reconstruction model for each frequency band;
determining a reconstruction error value showing a difference between the vibration signal for each frequency band and the reconstruction signal corresponding to each frequency band; and
determining a threshold value for anomaly detection corresponding to each of the defined frequency bands based on the reconstruction error value determined for each of the defined frequency bands.

12. The training method of claim 11, wherein the signal reconstruction model comprises at least one of an autoencoder, a stacked autoencoder, a long short-term memory (LSTM) autoencoder, and a convolutional autoencoder.

13. The training method of claim 11, wherein the determining of the reconstruction error value comprises determining the reconstruction error value based on at least one of an average value of differences between the vibration signal for each frequency band and the reconstruction signal corresponding to each frequency band, an average value of squares of the differences, and a square root value of the average value of the squares of the differences.

14. The training method of claim 11, wherein the determining of the threshold value comprises determining a threshold value of the reconstruction error value based on the three-sigma rule or a maximum value of the reconstruction error value for each frequency band.

15. An abnormality diagnosis method of diagnosing an anomaly of equipment performed by an abnormality diagnosis apparatus, the abnormality diagnosis method comprising:
obtaining a vibration signal of a time domain obtained by measuring a vibration that occurs in the equipment through a vibration sensor;
obtaining a vibration signal for each frequency band filtered according to the frequency band by inputting the vibration signal to at least one filter;
obtaining reconstruction signals corresponding to each defined frequency band from each signal reconstruction model by inputting the vibration signal for each frequency band to the signal reconstruction model corresponding to a frequency band;
determining a reconstruction error value showing a difference between the vibration signal for each frequency band and the reconstruction signal corresponding to each frequency band; and
determining the anomaly of the equipment based on an error value determined for each frequency band and a threshold value determined for each frequency band.

16. The abnormality diagnosis method of claim 15, wherein the determining of the anomaly of the equipment comprises, when at least one of the reconstruction error value determined for each frequency band is greater than a corresponding threshold value, determining that there is the anomaly in the equipment.

17. The abnormality diagnosis method of claim 15, wherein the determining of the anomaly of the equipment comprises, when the reconstruction error value determined for each frequency band is less than or equal to a corresponding threshold value, determining that the equipment is in a normal state.

18. The abnormality diagnosis method of claim 15, wherein the signal reconstruction model comprises at least one of an autoencoder, a stacked autoencoder, a long short-term memory (LSTM) autoencoder, and a convolutional autoencoder.

19. The abnormality diagnosis method of claim 15, wherein the determining of the reconstruction error value comprises determining the reconstruction error value based on at least one of an average value of differences between the vibration signal for each frequency band and the reconstruction signal corresponding to each frequency band, an average value of squares of the differences, and a square root value of the average value of the squares of the differences.

20. The abnormality diagnosis method of claim 15, further comprising:
as a result of comparing the reconstruction error value determined for each frequency band with the threshold value determined for each frequency band, when a frequency band in which the reconstruction error value is greater than a corresponding threshold value is detected, estimating an anomaly type based on the detected frequency band.
